(19) United States
(12) Patent Application Publication
(10) Pub. No.: US 2013/0057833 A1
(43) Pub. Date: Mar. 7, 2013

(54) ILLUMINATION OPTICAL SYSTEM AND A PROJECTOR USING THE SAME

(71) Applicant: Atsushi Katou, Tokyo (JP)

(72) Inventor: Atsushi Katou, Tokyo (JP)

(73) Assignee: NEC Display Solutions, Ltd., Tokyo (JP)

(21) Appl. No.: 13/696,593

(22) PCT Filed: May 21, 2010
(86) PCT No.: PCT/JP2010/058614

§ 371 Date: Nov. 6, 2012

(51) Int. Cl. G03B 21/14; F21S 19/00

(52) U.S. Cl. 353/31; 362/228

(57) ABSTRACT

The present invention seeks to realize an illumination optical system that has low etendues, a longer operating life and a higher brightness. The illumination optical system comprises: a laser light source that generates an excitation light; a fluorescent substance that generates a fluorescent light in response to the excitation light, a light tunnel that outputs the excitation light input at one end thereof to the fluorescent substance from the other end thereof, and that outputs the fluorescent light generated by the fluorescent substance from the one end thereof; and an optical element that is placed within a light path between the laser light source and the light tunnel, and that reflects the excitation light, but allows the fluorescent light to pass therethrough.

### TECHNICAL FIELD

The present invention relates to an illumination optical system for generating illumination lights of plural colors to form image lights of plural colors, and to a projector for projecting the image lights that are provided by the illumination optical system.

### BACKGROUND ART

Attention has been focused on the technology of utilizing LEDs (Light Emitting Diodes) as a light source of a projector for projecting images onto a screen, such as a liquid-crystal projector and a DMD (Digital Micromirror Device) projector (see Patent Document 1).

Projectors, which have LEDs as a light source, offer the advantage of a longer operating life and higher reliability due to a longer operating life and a higher reliability of LEDs.

However, since lights from LEDs have low brightness as lights for projectors, it is not easy to obtain images with ample brightness in projectors having LEDs as a light source. The amount of light from the light source that can be utilized by a display panel as a projection light, is limited by the etendue. Specifically, if the product of the light-emitting area and a radiation angle of the light source are not made equal to or smaller than the product of the area of an incidence plane of the display panel and an incident angle that is determined by a F number of an illumination optical system, then the light from the light source can not be efficiently utilized as projection light.

For a light source using LEDs, if the light-emitting area is increased, the amount of light can be increased, but the etendues of the light source becomes larger. From the limitation of etendues, for a light source of a projector, it is desired to increase the amount of light without increasing the light-emitting area. However, for a light source using LEDs, it is difficult to increase the amount of light without increasing the light-emitting area.

### LITERATURE OF THE PRIOR ART

### Patent Documents

Patent Document 1: JP2003-186110A

### SUMMARY OF INVENTION

### Problem to be Solved by the Invention

A light source using LEDs alone has the drawback of high etendues. The present invention seeks to realize an illumination optical system that has low etendues, longer operating life and higher brightness.

### Means to Solve the Problems

An illumination optical system according to the present invention comprises: a laser light source that generates an excitation light; a fluorescent substance that generates a fluorescent light in response to the excitation light; a light tunnel that outputs the excitation light input at one end thereof to the fluorescent substance from the other end thereof, and that outputs the fluorescent light generated by the fluorescent substance from the one end thereof; and an optical element that is placed within a light path between the laser light source and the light tunnel, and that reflects the excitation light, but allows the fluorescent light to pass therethrough.

In addition, a projector according to the present invention comprises the above-described illumination optical system

### Effects of the Invention

The present invention is capable of realizing an illumination optical system that has low etendues, a longer operating life and a higher brightness, because use is made of a fluorescent light that uses a laser having a high energy density as an excitation light.

### BRIEF EXPLANATIONS OF THE DRAWINGS

FIG. 1 is a block diagram illustrating the configuration of an illumination optical system according to an exemplary embodiment of the present invention.

FIG. 2A is a cross-sectional view of optical element 102.

FIG. 2B is an elevation view of optical element 102.

FIG. 3A is a plan view of the illumination optical system when fluorescent wheel 104 is seen from the side of the incidence plane of the laser light generated by laser light source 101.

FIG. 3B is a cross-sectional view illustrating the configurations of blue fluorescent area 201, green fluorescent area 202 and red fluorescent area 203.

FIG. 4 is a block diagram illustrating the configuration of an illumination optical system according to another exemplary embodiment of the present invention.

FIG. 5A is a block diagram illustrating the configuration of an illumination optical system according to another exemplary embodiment of the present invention.

FIG. 5B is a cross-sectional view of fluorescent substance 403 illustrating the configuration thereof.

FIG. 6 is a block diagram illustrating the configuration of an illumination optical system according to another exemplary embodiment of the present invention.

FIG. 7 is a block diagram illustrating the configuration of the circuitry of a projector that uses the illumination optical system of the exemplary embodiment shown in FIG. 1.

FIG. 8 is a block diagram illustrating the configuration of the circuitry of a projector that uses the illumination optical system of the exemplary embodiment shown in FIG. 4.

### MODES FOR CARRYING OUT THE INVENTION

Exemplary embodiments of the present invention will be described hereinafter with reference to the drawings. In the following explanations, components having the same functions are assigned identical reference numerals and explanations thereof may be omitted.

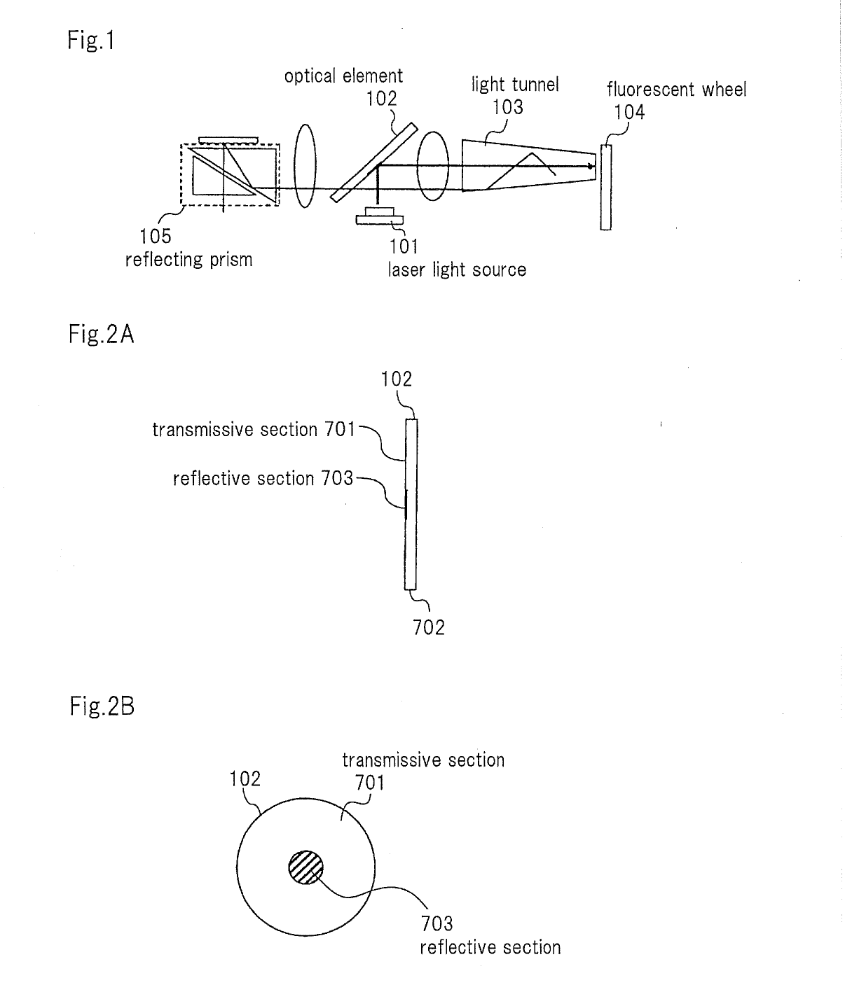

FIG. 1 is a block diagram illustrating the configuration of an illumination optical system according to an exemplary embodiment of the present invention.

As shown in FIG. 1, the illumination optical system of the exemplary embodiment comprises laser light source 101, optical element 102, light tunnel 103, fluorescent wheel 104 and reflecting prism 15.

Laser light source 101 generates laser light used as an excitation light with a wavelength of λ1. The laser light that is generated by laser light source 101 is reflected by optical element 102, passes through light tunnel 103 and enters fluorescent wheel 104.

Optical element 102 is located within a light path between laser light source 101 and light tunnel 103.

Optical element 102 is an element that reflects the laser light toward the fluorescent wheel through light tunnel 103, and allows the fluorescent light generated by fluorescent wheel 104 to pass through the optical element. In the present exemplary embodiment, optical element 102 has a reflective section that reflects the laser light, but allows the fluorescent light to pass through the section other than the reflective section.

FIG. 2A is a cross-sectional view of optical element 102, and FIG. 2B is an elevation view of optical element 102.

As shown in FIGS. 2A and 2B, optical element 102 includes transmissive section 701 that is a transmission area that allows the fluorescent light to pass through the section, and reflective section 703 that is a reflective area that reflects the laser light.

Reflective section 703 is formed by, for example, evaporating aluminum, chrome, etc. on transparent substrate 702 such as a flat glass. Transmissive section 701 is formed by, for example, providing a non-evaporation section on substrate 702. In short, reflective section 703 needs only to be formed such that it reflects the laser light (the excitation light).

The shape of substrate 702 is not limited to circular shown in FIGS. 2A and 2B, but may be rectangular and other shapes. The shape of reflective section 703 is also not limited to circular.

Additionally, as shown in FIG. 1, optical element 102 may preferably be arranged at an angle with respect to the direction of travel of the laser.

In general, in many cases, the cross-sectional shape of the light emitted from a semiconductor laser is not circular, but ellipsoidal. Accordingly, when reflective section 703 is circular in shape, for example, the shape of reflective section 703 is ellipsoidal when it is seen from light source 101 in FIG. 1. Therefore, if the orientation of the long axis of the cross-section of the laser light is matched to the orientation of the long axis of reflective section 703, then the laser light can be efficiently reflected by reflective section 703.

Fluorescent wheel 104 has a plurality of fluorescence generation areas that generate lights with differing wavelengths in response to the laser signal generated by laser light source 101.

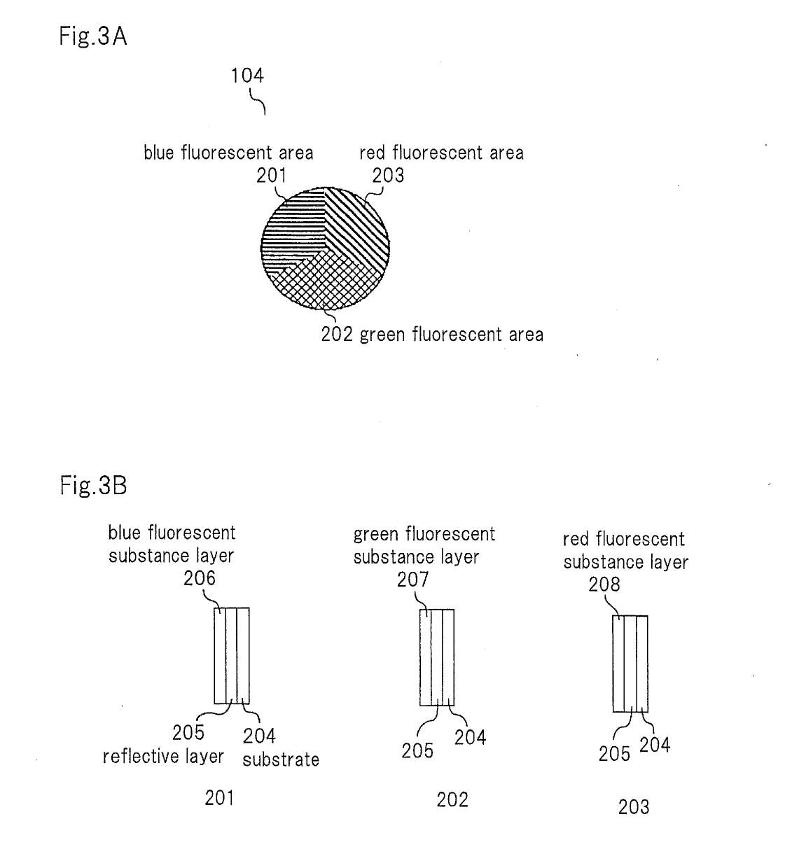

FIG. 3A is a plan view of the illumination optical system when fluorescent wheel 104 is seen from the side of the incidence plane of the laser light generated by laser light source 101, i.e., when fluorescent wheel 104 is seen from the left-hand side in FIG. 1.

Fluorescent wheel 104 is circular in shape, and has three areas defined by their center angles: blue fluorescent area 201, green fluorescent area 202 and red fluorescent area 203. Blue fluorescent area 201, green fluorescent area 202 and red fluorescent area 203 generate, when the laser light generated by laser light source 101 enters the respective areas, blue fluorescent light, green fluorescent light and red fluorescent light, respectively. The blue fluorescent light, green fluorescent light and red fluorescent have respective wavelengths of λ2, λ3 and λ4, wherein λ1<λ3<λ4 and λ1 is the wavelength of the laser light.

FIG. 3B is a cross-sectional view illustrating the configurations of blue fluorescent area 201, green fluorescent area 202 and red fluorescent area 203.

In blue fluorescent area 201 shown in FIG. 3B, reflective layer 205 and blue fluorescent substance layer 206 are laminated on substrate 204. Reflective layer 205 reflects light with wavelengths of λ2 to λ4. Blue fluorescent substance layer 206 generates blue fluorescent light with a wavelength of λ2 when the laser light that is used as excitation light with a wavelength of λ1 enters the layer.

In green fluorescent area 202 shown in FIG. 3B, green fluorescent substance layer 207 is laminated on reflective layer 205. Green fluorescent substance layer 207 generates green fluorescent light with a wavelength of λ3 when the laser light that is used as excitation light with a wavelength of λ1 enters the layer.

In red fluorescent area 203 shown in FIG. 3B, red fluorescent substance layer 207 is laminated on reflective layer 205. Red fluorescent substance layer 207 generates red fluorescent light with a wavelength of λ4 when the laser light that is used as excitation light with a wavelength of λ1 enters the layer.

Fluorescent wheel 104 configured above rotates about its central axis whereby the laser light irradiated from light tunnel 103 moves on the respective fluorescent areas. The laser light generated by laser light source 101 enters near the periphery of fluorescent wheel 104. Therefore, in a state in which the laser light generated by laser light source 101 enters fluorescent wheel 104, the blue fluorescent light, the green fluorescent light and the red fluorescent light are sequentially generated, and are reflected by reflective layer 205 to reenter light tunnel 103.

Fluorescent wheel 104 configured above rotates about its central axis whereby the laser light irradiated from light tunnel 103 moves on the respective fluorescent areas. The laser light generated by laser light source 101 enters near the periphery of fluorescent wheel 104. Therefore, in a state in which the laser light generated by laser light source 101 enters fluorescent wheel 104, the blue fluorescent light, the green fluorescent light and the green fluorescent light are sequentially generated, and are reflected by reflective layer 205 to reenter light tunnel 103.

In the present exemplary embodiment, lights with four wavelengths (λ1˜λ4) having the relationship λ1<λ2<λ3<λ4 are used. Optical element 102 reflects a large portion of lights with the wavelength of λ2, λ3 and λ4, and light with a wavelength of λ1 passes through opening 106. Light tunnel 103 is tapered such that both end faces thereof, which serve as the entrance face and as the exist face, respectively, have different sizes. This changes the angular distributions of fluorescent lights that are generated and diffused by each fluorescent substance to make the distribution of the fluorescent lights uniform. The light tunnel described herein includes: one that is hollow and has an inner wall constituted by a mirror; and one that is solid and is formed by transparent polygonal columns to utilize total reflection. The latter is also called a rod lens.

In the present exemplary embodiment, the laser light is reflected by reflective section 703, enters one end of light tunnel 103, passes therethrough, and exits the other end of light tunnel 103 towards fluorescent wheel 104. The blue fluorescent light, the green fluorescent light and the red fluorescent light that are sequentially generated by fluorescent wheel 104 reenter light tunnel 103 and exit the one end of light tunnel 103, the large portion of which passes through transmissive section 701 of optical element 102. Thereafter, the fluorescent light that has passed through transmissive section 701 is reflected by reflecting prism 105 and is radiated as illumination light.

Here, the reason why a large portion of each fluorescent light passes through transmissive section 701 is that since the laser light is a beam-like light with a very small spread, and since reflective section 703 of optical element 102 has a small area which is dependent on the cross-sectional area of the beam, large portions of lights with wavelengths of λ2, λ3 and λ4 are not screened by reflective section 703.

As discussed hereinabove, in the illumination optical system according to the present exemplary embodiment, uniform red fluorescent light, green fluorescent light and blue fluorescent light appear in order, and are used as an illumination light.

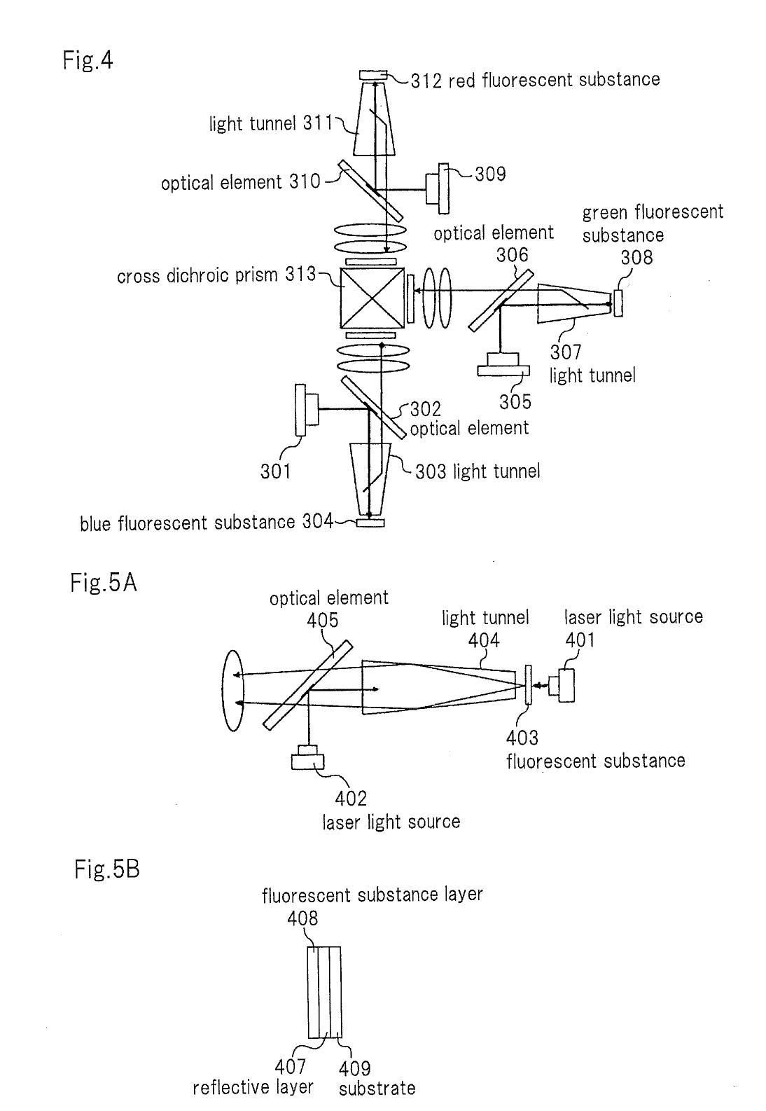

FIG. 4 is a block diagram illustrating the configuration of an illumination optical system according to another exemplary embodiment of the present invention.

In the exemplary embodiment shown in FIG. 1, use is made of the fluorescent wheel having three fluorescent areas to generate fluorescent lights of three colors from one excitation light source. By contrast, in the present exemplary embodiment, excitation light sources are provided, each being associated with a fluorescent substance of each color.

The illumination optical system according to the present exemplary embodiment comprises laser light sources 301, 305, 309, optical elements 302, 306, 310, light tunnels 303, 307, 311, blue fluorescent substance 304, green fluorescent substance 308, red fluorescent substance 312 and cross dichroic prism 313.

Laser light sources 301, 305 and 309 generate laser lights that are used as excitation lights with a wavelength of λ1. Blue fluorescent substance 304, green fluorescent substance 308 and red fluorescent substance 312 generate a blue fluorescent light, a green fluorescent light and a red fluorescent light, respectively, when the laser light generated by laser light source 301 enters the respective areas. The blue fluorescent light, green fluorescent and red fluorescent have respective wave lengths λ2, λ3 and λ4, wherein λ2<λ3<λ4.

Blue fluorescent substance 304, green fluorescent substance 308 and red fluorescent substance 312 have configurations similar to blue fluorescent area 201, green fluorescent area 202 and red fluorescent area 203 shown in FIG. 3B, in which the blue fluorescent substance, the green fluorescent substance and the red fluorescent substance are formed on the reflective layers formed on the substrate.

Optical element 302 reflects the light with the wavelength of λ1, but allows a large portion of the light with a wavelength of λ2 to pass therethrough. Optical element 306 reflects the light with a wavelength of λ1, but allows a large portion of the light with a wavelength of λ3 to pass therethrough. Optical element 310 reflects the light with a wavelength of λ1, but allows a large portion of the light with a wavelength of λ3 to pass therethrough.

Similar to light tunnel 103 shown in FIG. 1 , light tunnels 303, 307 and 311 are tapered such that both end faces thereof, which serve as the entrance face and the exist face, respectively, have different sizes. This changes the angular distributions of fluorescent lights that are generated and diffused by each fluorescent substance to make the distributions of the fluorescent lights uniform. The light tunnel described herein includes one that is hollow and has an inner wall that is constituted by a mirror; and one that is solid and is formed by transparent polygonal columns to utilize total reflection.

Laser light generated by laser light source 301 is reflected by optical element 302, passes through light tunnel 303, and enters blue fluorescent substance 304. The blue fluorescent light generated by blue fluorescent substance 304 passes through light tunnel 303, and a large portion of the blue fluorescent light passes through optical element 302 to enter cross dichroic prism 313.

Laser light generated by laser light source 305 is reflected by optical element 306, passes through light tunnel 307, and enters green fluorescent substance 308. The green fluorescent light generated by green fluorescent substance 308 passes through light tunnel 307, and a large portion of the green fluorescent light passes through optical element 306 to enter cross dichroic prism 313.

Laser light generated by laser light source 309 is reflected by optical element 310, passes through light tunnel 311, and enters red fluorescent substance 312. Red fluorescent light generated by red fluorescent substance 312 passes through light tunnel 311, and a large portion of the red fluorescent light passes through optical element 310 to enter cross dichroic prism 313.

Cross dichroic prism 313 allows light with a wavelength of λ3 to pass therethrough, but reflects lights with wavelengths of λ2 and λ4. This allows the fluorescent lights generated by the respective fluorescent substances to be emitted in the same direction.

In the present exemplary embodiment configured above, it is possible to generate a plurality of fluorescent lights simultaneously because a unit for generating a fluorescent light is provided for each color. Further, by driving laser light sources 301, 305 and 309 in order, the fluorescent lights can be sequentially output, similar to the illumination optical system shown in FIG. 1.

FIG. 5A is a block diagram illustrating the configuration of an illumination optical system according to another exemplary embodiment of the present invention.

The present exemplary embodiment is a modification of, among the units each associated with each color in the embodiment shown in FIG. 3, a unit in which an excitation light generated by the laser light source passes through a reflective mirror with an opening and enters the light tunnel. This modification is intended to increase light output.

As shown in FIG. 5A, the illumination optical system of the present exemplary embodiment comprises laser light sources 401, 402, fluorescent substance 403, light tunnel 404 and optical element 405. Laser light sources 401 and 402 generate laser lights with the same wavelength, as an excitation light. Laser light source 401 is a second laser light source that irradiates the excitation light towards fluorescent substance 403 from the side of fluorescent substance 403 opposite to light tunnel 404.

FIG. 5B is a cross-sectional view of fluorescent substance 403 illustrating the configuration thereof. As shown, fluorescent substance 403 has a configuration in which reflective layer 407 and fluorescent substance layer 408 are laminated on substrate 409. Fluorescent substance layer 408 generates a fluorescent light having a wavelength larger than those of the laser lights generated by laser light sources 401 and 402 in response to the laser lights. Reflective layer 407 allows the laser lights generated by laser light sources 401 and 402 to pass therethrough, but reflects the fluorescent light generated by fluorescent substance layer 408. Reflective layer 407 is formed by a dielectric multilayer etc. that has thin films with properties to pass through a laser light and reflect a fluorescent light.

Optical element 405 reflects a laser light generated by laser light source 401, but allows a large proportion of the fluorescent light generated by fluorescent substance layer 408 to pass therethrough.

The laser light generated by laser light source 401 passes through reflective layer 407, and enters fluorescent substance layer 408. The laser light generated by laser light source 402 is reflected by optical element 405, and enters fluorescent substance layer 408. Fluorescent substance layer 408 generates a fluorescent light due to the entered laser lights from laser light sources 401 and 402. The fluorescent light generated by fluorescent substance layer 408 is output outwards through light tunnel 404 and the transmissive section of optical element 405 for use as an illumination light.

Fluorescent substance 403 in the present exemplary embodiment may be configured as fluorescent wheel shown in FIG. 1 to form an illumination optical system which sequentially outputs fluorescent lights of respective colors. The unit in the present exemplary embodiment may be converted into three separate units that generate differing fluorescent lights to form the illumination optical system shown in FIG. 3.

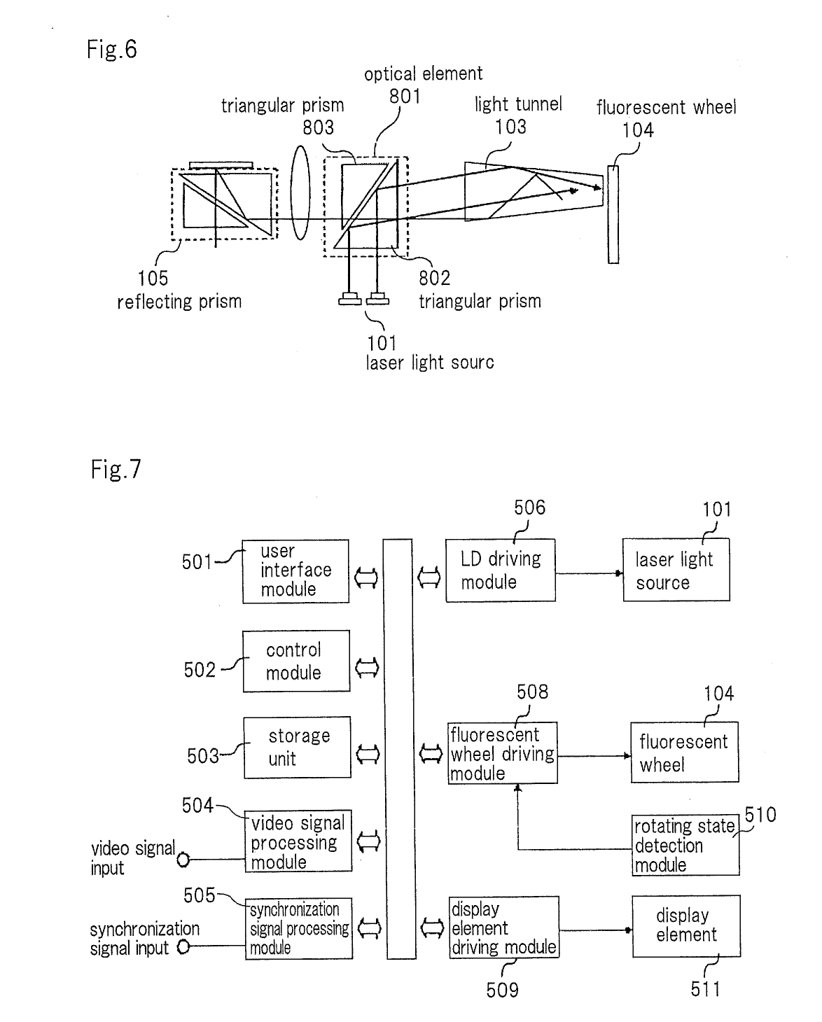

FIG. 6 is a block diagram illustrating the configuration of an illumination optical system according to another exemplary embodiment of the present invention.

The present exemplary embodiment is a modification of the illumination optical system that is explained with reference to FIG. 1. This modification is intended to increase light output by using a plurality of laser light sources.

As shown in FIG. 6, the illumination optical system of the present exemplary embodiment comprises a plurality of laser light sources 101, light tunnel 103, fluorescent wheel 104, reflecting prism 105 and optical element 801.

The configurations and operations of laser light sources 101, light tunnel 103, fluorescent wheel 104 and reflecting prism 105 are similar to those in FIG. 1, and their explanations are omitted by denoting them by identical reference numerals in FIG. 1.

Optical element 801 is made up of two triangular prisms 802 and 803 that are integrated together in such a way that the inclined planes of the triangular prisms face each other via an air gap which is a minute gap. In addition, triangular prism 802 is arranged such that each laser light is totally reflected by the inclined plane.

Laser lights generated by the respective laser light sources 101 are totally reflected by the inclined plane of triangular prism 802 of optical element 801, and are led to the incidence plane of light tunnel 103. Thereafter, the laser light enters fluorescent wheel 104 where fluorescent light is generated. The generated fluorescent light passes through light tunnel 103 to be output, passes through two triangular prisms 802 and 803 that constitute optical element 801, and is reflected by reflecting prism 105 to be output as an illumination light.

Since triangular prisms 802 and 803 are arranged in such a way that the inclined planes face each other via a minute air gap, it is possible to lower light loss when the fluorescent light that is emitted from light tunnel 103 and that has a limited spread angle, passes through optical element 801. Furthermore, since use of plural laser light sources 101 is possible, fluorescent lights that have a large amount of light can be utilized depending on the number of laser light sources, thus realizing a very bright projector.

FIG. 7 is a block diagram illustrating the configuration of the circuitry of a projector that uses the illumination optical system of the exemplary embodiment shown in FIG. 1.

The projector shown in FIG. 7 comprises user interface module 501, control module 502, storage unit 503, video signal processing module 504, synchronization signal processing module 505, LD driving module 506, fluorescent wheel driving module 508, display element driving module 509, rotating state detection module 510, display element 511, laser light source 101 shown in FIG. 1 and fluorescent wheel 104 shown in FIG. 1.

User interface module 501 receives an instruction input from a user and outputs the same to control module 502. User interface module 501 also displays the current operation state of the projector on a display unit (not shown) such as an indicator, a display panel, etc.

Control module 502 controls each module that constitutes the projector in accordance with a program stored in storage unit 503.

Storage unit 503 stores the control program of control module 502, and also stores video data temporally.

Video signal processing module 504 converts a video signal that is input from outwards into a video signal used in the projector. As explained above, since the present exemplary embodiment is configured such that illumination lights of respective colors are sequentially output from the illumination optical system, video signals based on the respective colors are sequentially generated.

Synchronization signal processing module 505 converts a synchronization signal synchronized with a video signal that is input from outwards into a video signal used in the projector. Specifically, synchronization signal processing module 505 generates and outputs a synchronization signal indicative of timings to output video signals of respective colors.

LD driving module 506 controls the lighting state of laser light source 101 based on the synchronization signal that is output by synchronization signal processing module 505.

Rotating state detection module 510 detects the rotating state of fluorescent wheel 104, and outputs the result to fluorescent wheel driving module 508.

Fluorescent wheel driving module 508 controls the rotating state of fluorescent wheel 104 such that the color of a video signal indicated in the synchronization signal that is output by synchronization signal processing module 505 matches the color that is output by the illumination optical system, and indicates the rotating state of fluorescent wheel 104 that is detected by rotating state detection module 510.

Display element driving module 509 drives display element 511 based on the video signal that is output by the video signal processing module. Here, as display element 511, use is made of a reflective-type image-forming element in which a plurality of micro mirrors are arranged in a matrix form and an image is formed due to the reflection state of each micro mirror, and a display element that sequentially displays images of respective colors, such as a transmissive liquid crystal display element, a reflective liquid crystal display element, etc.

In the projector configured above, display element 511 is illuminated which displays an image corresponding to the respective colors based on the illumination lights of the respective colors that are sequentially output from the illumination optical system, and the reflected images or the transmissive images of display element 511 are sequentially projected through the illumination optical system (not shown).

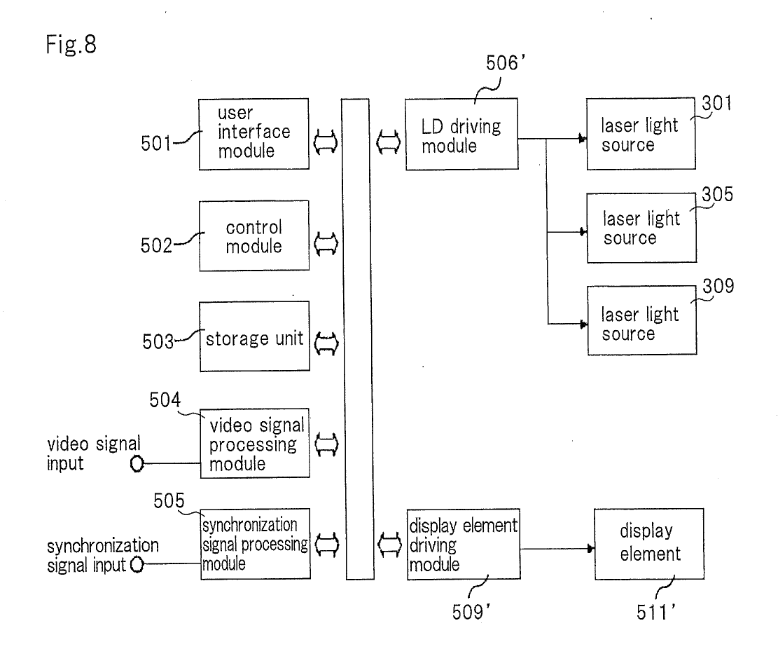

FIG. 8 is a block diagram illustrating the configuration of the circuitry of a projector that uses the illumination optical system of the exemplary embodiment shown in FIG. 4.

The projector shown in FIG. 8 comprises user interface module 501, control module 502, storage unit 503, video signal processing module 504, synchronization signal processing module 505, LD driving module 506′, display element driving module 509′, display element 511 and laser light sources 301, 305 and 309 shown in FIG. 4.

The configurations and operations of user interface module 501, control module 502, storage unit 503, video signal processing module 504, synchronization signal processing module 505 are similar to those shown in FIG. 7, and their explanations are omitted by denoting them by identical reference numerals in FIG. 7.

LD driving module 506′ controls the lighting state of laser light sources 301, 305 and 309 based on the synchronization signal that is output by synchronization signal processing module 505.

Display element driving module 509′ drives display element 511′ based on a video signal that is output by the video signal processing module. Here, similar to display element 511 shown in FIG. 7, as display element 511′, use is made of a reflective-type image-forming element in which a plurality of micro mirrors are arranged in a matrix form and an image is formed due to the reflection state of each micro mirror, and a display element that sequentially displays images of respective colors, such as a transmissive liquid crystal display element, a reflective liquid crystal display element, etc. LD driving module 506′ thus energizes laser light sources 301, 305 and 203 in accordance with the color of an image that is displayed by display element 511′.

The transmissive liquid crystal display element and the reflective liquid crystal display element can include ones that display color images. When a display element that performs color display is used as display element 511′, LD driving module 506′ energizes laser light sources 301, 305 and 309 simultaneously.

In the projector configured above, display element 511′ is illuminated which displays an image corresponding to the respective colors based on the illumination lights of the respective colors that are output sequentially from the illumination optical system, and reflective images or transmissive images of display element 511′ are sequentially projected through the illumination optical system (not shown).

The configurations illustrated in the figures in the above-described embodiments are given by way of example only, and the present invention should not be limited thereto.

### Explanations of Reference Characters

101 laser light source

102 optical element

103 light tunnel

104 fluorescent wheel

105 reflecting prism

1. An illumination optical system comprising:
a laser light source that generates an excitation light;
a fluorescent substance that generates a fluorescent light in response to the excitation light;
a light tunnel that outputs the excitation light input at one end thereof to said fluorescent substance from the other end thereof, and that outputs the fluorescent light generated by said fluorescent substance from the one end thereof; and
an optical element that is placed within a light path between said laser light source and said light tunnel, and that reflects the excitation light, but allows the fluorescent light to pass therethrough.

2. The illumination optical system according to claim 1, wherein said optical element includes: a reflective section that reflects the excitation light; and a transmissive section that allows the fluorescent light to pass therethrough.

3. The illumination optical system according to claim 1, wherein said optical element comprises two triangular prisms that are placed in such a way that their inclined planes face each other via an air gap.

4. The illumination optical system according to claim 3, wherein there are a plurality of said laser light sources.

5. The illumination optical system according to claim 1, wherein said fluorescent substance comprises a fluorescent wheel that has a plurality of fluorescent areas that generate fluorescent lights with differing wavelengths, said fluorescent wheel being rotated whereby the position on said fluorescent wheel that is irradiated by said light tunnel moves on the respective fluorescent areas.

6. An illumination optical system comprising a plurality of units, each constituted by said illumination optical system according to claim 1, wherein said fluorescent substance in each unit generates a fluorescent light with a differing wavelength, and wherein each unit further comprises a cross dichroic prism that inputs the output light from the unit and outputs the output light in the same direction.

7. The illumination optical system according to claim 1, further comprising a second light source that emits an excitation light towards said fluorescent substance from the side of fluorescent substance opposite to said light tunnel, and wherein said fluorescent substance comprises a reflective layer that is located at the side of said second light source, allows the excitation light to pass therethrough, but reflects the fluorescent light; and a fluorescent substance layer that is located at the side of said light tunnel.

8. A projector having an illumination optical system according to claim 1.

9. The illumination optical system according to claim 2, wherein said fluorescent substance comprises a fluorescent wheel that has a plurality of fluorescent areas that generate fluorescent lights with differing wavelengths, said fluorescent wheel being rotated whereby the position on said fluorescent wheel that is irradiated by said light tunnel moves on the respective fluorescent areas.

10. The illumination optical system according to claim 3, wherein said fluorescent substance comprises a fluorescent wheel that has a plurality of fluorescent areas that generate fluorescent lights with differing wavelengths, said fluorescent wheel being rotated whereby the position on said fluorescent wheel that is irradiated by said light tunnel moves on the respective fluorescent areas.

11. The illumination optical system according to claim 4, wherein said fluorescent substance comprises a fluorescent wheel that has a plurality of fluorescent areas that generate fluorescent lights with differing wavelengths, said fluorescent wheel being rotated whereby the position on said fluorescent wheel that is irradiated by said light tunnel moves on the respective fluorescent areas.

12. An illumination optical system comprising a plurality of units, each constituted by said illumination optical system according to claim 2, wherein said fluorescent substance in each unit generates a fluorescent light with a differing wavelength, and wherein each unit further comprises a cross dichroic prism that inputs the output light from the unit and outputs the output light in the same direction.

13. An illumination optical system comprising a plurality of units, each constituted by said illumination optical system according to claim 3, wherein said fluorescent substance in each unit generates a fluorescent light with a differing wavelength, and wherein each unit further comprises a cross dichroic prism that inputs the output light from the unit and outputs the output light in the same direction.

14. An illumination optical system comprising a plurality of units, each constituted by said illumination optical system according to claim 4, wherein said fluorescent substance in each unit generates a fluorescent light with a differing wavelength, and wherein each unit further comprises a cross dichroic prism that inputs the output light from the unit and outputs the output light in the same direction.

15. The illumination optical system according to claim 2, wherein it further comprises a second light source that emits an excitation light towards said fluorescent substance from the side of fluorescent substance opposite to said light tunnel, and wherein said fluorescent substance comprises a reflective layer that is located at the side of said second light source, allows the excitation light to pass therethrough, but reflects the fluorescent light; and a fluorescent substance layer that is located at the side of said light tunnel.

16. The illumination optical system according to claim 3, further comprising a second light source that emits an excitation light towards said fluorescent substance from the side of fluorescent substance opposite to said light tunnel, and wherein said fluorescent substance comprises a reflective layer that is located at the side of said second light source, allows the excitation light to pass therethrough, but reflects the fluorescent light; and a fluorescent substance layer that is located at the side of said light tunnel.

17. The illumination optical system according to claim 4, further comprising a second light source that emits an excitation light towards said fluorescent substance from the side of fluorescent substance opposite to said light tunnel, and wherein said fluorescent substance comprises a reflective layer that is located at the side of said second light source, allows the excitation light to pass therethrough, but reflects the fluorescent light; and a fluorescent substance layer that is located at the side of said light tunnel.

18. The illumination optical system according to claim 5, further comprising a second light source that emits an excitation light towards said fluorescent substance from the side of fluorescent substance opposite to said light tunnel, and wherein said fluorescent substance comprises a reflective layer that is located at the side of said second light source, allows the excitation light to pass therethrough, but reflects the fluorescent light; and a fluorescent substance layer that is located at the side of said light tunnel.

19. The illumination optical system according to claim 6, further comprising a second light source that emits an excitation light towards said fluorescent substance from the side of fluorescent substance opposite to said light tunnel, and wherein said fluorescent substance comprises a reflective layer that is located at the side of said second light source, allows the excitation light to pass therethrough, but reflects the fluorescent light; and a fluorescent substance layer that is located at the side of said light tunnel.

20. A projector having an illumination optical system according to claim 2.
